(19) United States
(12) Patent Application Publication
(10) Pub. No.: US 2015/0032963 A1
(43) Pub. Date: Jan. 29, 2015

(54) DYNAMIC SELECTION OF CACHE LEVELS

(71) Applicant: LSI Corporation, San Jose, CA (US)

(72) Inventors: Maghawan Neelkanth Punde, Pune (IN); Pallavi Amit KULKARNI, Pune (IN); Aniket Prakash Deshpande, Pune (IN)

(73) Assignee: LSI Corporation, San Jose, CA (US)

(21) Appl. No.: 13/959,978

(22) Filed: Aug. 6, 2013

Related U.S. Application Data
(60) Provisional application No. 61/859,340, filed on Jul. 29, 2013.

(51) Int. Cl. G06F 12/08

(52) U.S. Cl. CPC G06F 12/0811
USPC 711/122

(57) ABSTRACT

An apparatus having a first circuit and a second circuit is disclosed. The first circuit is configured to generate an access request having a first address. The second circuit is configured to (i) initiate a change in a load value of a cache system in response to the access request. The cache system has a plurality of levels. The load value represents a work load on the cache system. The second circuit is further configured to (ii) generate a second address from the first address in response to the load value and (iii) route the access request to one of the levels in the cache system in response to the second address.

This application relates to U.S. Provisional Application No. 61/859,340, filed Jul. 29, 2013, which is hereby incorporated by reference in its entirety.

### FIELD OF THE INVENTION

The invention relates to cache systems generally and, more particularly, to a method and/or apparatus for implementing a dynamic selection of cache levels.

### BACKGROUND

Power and area constraints limit a size and a bandwidth of cache systems on conventional chips. For processors and hardware engines to perform efficiently, the bandwidth and data pollution in each cache is actively managed. However, allocation of data used and produced by the hardware engines to different cache levels is inefficiently managed or commonly fixed. Therefore, the hardware engines sometimes interfere with the performance of the processors by over utilizing faster levels of the cache systems.

### SUMMARY

The invention concerns an apparatus having a first circuit and a second circuit. The first circuit is configured to generate an access request having a first address. The second circuit is configured to (i) initiate a change in a load value of a cache system in response to the access request. The cache system has a plurality of levels. The load value represents a work load on the cache system. The second circuit is further configured to (ii) generate a second address from the first address in response to the load value and (iii) route the access request to one of the levels in the cache system in response to the second address.

### BRIEF DESCRIPTION OF THE FIGURES

Embodiments of the invention will be apparent from the following detailed description and the appended claims and drawings in which:

FIG. 1 is a block diagram of an apparatus;

FIG. 2 is a detailed block diagram of the apparatus in accordance with an embodiment of the invention;

FIGS. 3A-3B are a flow diagram of a method for selecting between the cache levels;

FIG. 4 is a flow diagram of a method for remapping addresses;

FIG. 5 is a flow diagram of a method for routing the remapped addresses; and

FIG. 6 is a flow diagram of a method for demapping the addresses.

### DETAILED DESCRIPTION OF THE EMBODIMENTS

Embodiments of the invention include providing a dynamic selection of cache levels that may (i) reallocate data from hardware engines to different levels of the cache, (ii) allow software to control hardware engine cache allocation policies, (iii) reduce pollution of processor-cached data, (iv) reduce memory bandwidth compared with conventional approaches, (v) reduce power consumption compared with conventional approaches and/or (vi) be implemented on one or more integrated circuits.

Embodiments of the invention generally provide dynamic selection of allocation points in a hierarchical memory sub system based on workloads. In an example embodiment, a processor or hardware engine selects the allocation point in the system memory hierarchy for improved power and/or performance with minimal additional silicon area and power. Control of the hardware engine cache allocation policy reduces pollution of the processor caches, saves system memory bandwidth and saves overall power consumption.

Allocation operations are based on multiple (e.g., two) disjoint intelligent functions: software or hardware that tracks a system level load on the cache system; and an ability of the processors or the hardware engines to alter quality of service (e.g., QOS) values and/or memory operation codes. The alterations are based on configuration registers in the hardware engines. The software running in the processors re-programs the values in the configuration registers by making regular writes to the addresses assigned to the configuration registers.

Under normal loading conditions, a hardware engine designer initially selects which data structures are allocated to a level-2 (e.g., L2) cache, a level-3 (e.g., L3) cache or bypass the cache. The selection is usually indicated by subtypes of read/write operation codes. The choice between allocations into the level-2 cache versus the level-3 cache is design dependent and candidates are the quality of service identifiers, a range of access request (or transaction) identifiers and an address range. A decision of what should be the quality of service identifier values and/or transaction identifiers depend on a particular data structure being implemented.

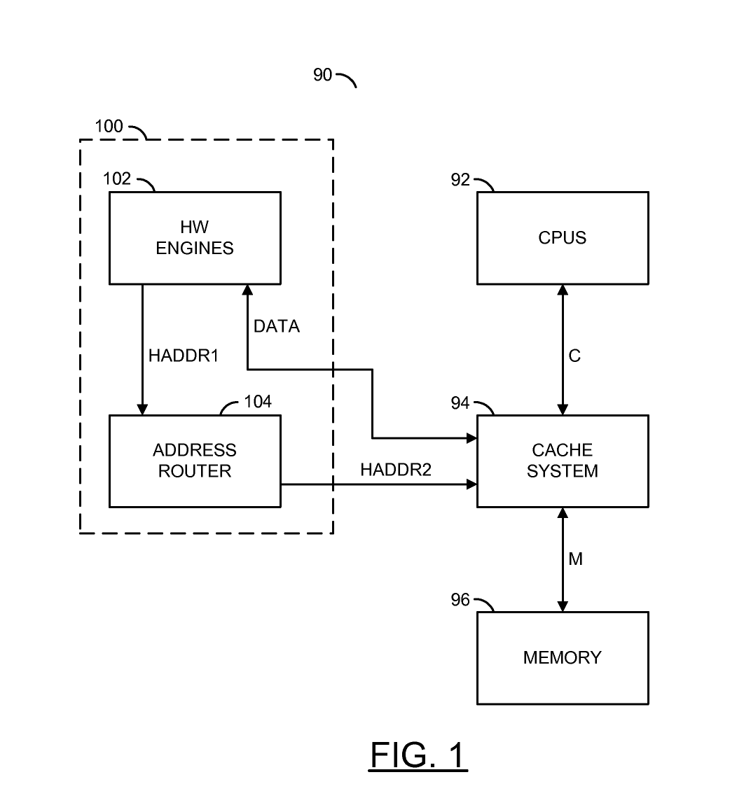

Referring to FIG. 1, a block diagram of an apparatus 90 is shown. The apparatus (or system) 90 may implement a computer system having a dynamic adjustable cache system. The apparatus 90 generally comprises one or more blocks (or circuits) 92, a block (or circuit) 94, a block (or circuit) 96 a block (or circuit) a block (or circuit) 100. The circuit 100 generally comprises one or more blocks (or circuits) 102 and a block (or circuit) 104. The circuits 92 to 104 may represent modules and/or blocks that may be implemented as hardware, software, a combination of hardware and software, or other implementations.

A signal (e.g., HADDR1) is shown generated by the circuit 102 and presented to the circuit 104. The signal HADDR1 may convey addresses generated by the circuit 102 to access information stored in the circuits 94 and/or 96. A signal (e.g., DATA) is shown exchanged between the circuit 102 and the circuit 94. The signal DATA carries data written to and/or read from the circuits 94 and/or 96. The circuit 104 is shown generating a signal (e.g., HADDR2) transferred to the circuit 94. The signal HADDR2 conveys allocated versions of the addresses received in the signal HADDR1. A signal (e.g., C) is shown being exchanged between the circuits 92 and 94. The signal C transfers addresses, data and instructions between the circuits 92 and 94. A signal (e.g., M) is shown exchanged between the circuits 94 and 96. The signal M transfers addresses, data and instructions between the circuits 94 and 96.

The circuit 92 is shown implementing one or more processor circuits. The circuit 92 is operational to execute software (or program instructions or firmware) to perform a variety of tasks. Some tasks include programming the circuits 102 and/or 104 to control the dynamic allocation of the cache policies of the circuit 102.

The circuit 94 is shown implementing a multi-level cache circuit. The circuit (or system) 94 is operational to cache data and instructions between the circuits 92 and 96 and between the circuits 96 and 102. In some embodiments, the circuit 94 has at least three levels of cache (e.g., L1, L2 and L3). In some embodiments, the circuit 94 has four or more levels of cache (e.g., L1, L2, L3, L4, . . . ).

The circuit 96 is shown implementing a memory circuit. The circuit 96 is operational to store the data and instruction used by and generated by the circuits 92 and 102. In some embodiments, the circuit 96 implements solid state memory (e.g., dynamic random access memory). In other embodiments, the circuit 96 implements a mass storage circuit, such as one or more hard disk drives, optical drives and/or solid-state drives (e.g., flash memory). Other memory technologies may be implemented to meet the criteria of a particular application.

The circuit (or apparatus or device or integrated circuit) 100 is shown implementing a hardware acceleration circuit. In some embodiments, the circuit 100 comprises one or more integrated circuits (or chips or die). The circuit 100 is operational to provide one or more hardware engines designed to perform specific operations. The circuit 100 exchanges data and information with the circuit 92 through the circuits 94 and/or 96. The circuit 100 acts as a slave to the circuit 92. Therefore, in some situations, the operations performed in the circuit 100 are of a lower priority than the operations performed in the circuit 92. As such, the caching policy of the circuit 100 is flexible to avoid interfering with the operations executing in the circuit 92.

The circuit 102 is shown implementing one or more hardware engines. Each hardware engine in the circuit 102 is operational to perform one or more of the operations of the circuit 100. The circuit 102 reads and writes data and information to and from the memory subsystem (e.g., the circuits 94 and 96) using the signals HADDR1 and DATA.

In some embodiments, the circuit 102 generates one or more access requests (e.g., read access requests or write access requests) having one or more corresponding addresses. The addresses generally identify in a virtual address range or a physical address range where the data and/or information is located. For a cache hit, the access request is serviced directly from the circuit 94. For a cache miss, the access request is serviced from the circuit 96 through the circuit 94. Non-cached access requests are serviced from the circuit 96.

The circuit 104 is shown implementing an address router circuit. The circuit 104 is operational to generate the signal HADDR2 by selectively modifying/not modifying the addresses received in the signal HADDR1. In some embodiments, the modification involves appending a bit to each address and entering a value into the new bit. The value entered into the new bit is used to determine which cache level of the circuit 94 is used for the access request. The extra bit is stripped from the addresses before being presented in the signal HADDR2.

In some embodiments, the circuit 104 is configured to adjust a pointer that initiates a change in a hardware work load value of the circuit 94 as part of a response to an access request from the circuit 102. The hardware work load value represents a work load level on the caching system. In some embodiments, the hardware work load value is maintained in the circuit 96 by the software executing in the circuit 92. The circuit 104 is also configured to generate another address from the address received from the circuit 102 in response to the hardware work load value. The circuit 104 further routes the access request to one of the levels in the cache system in response to modified addresses.

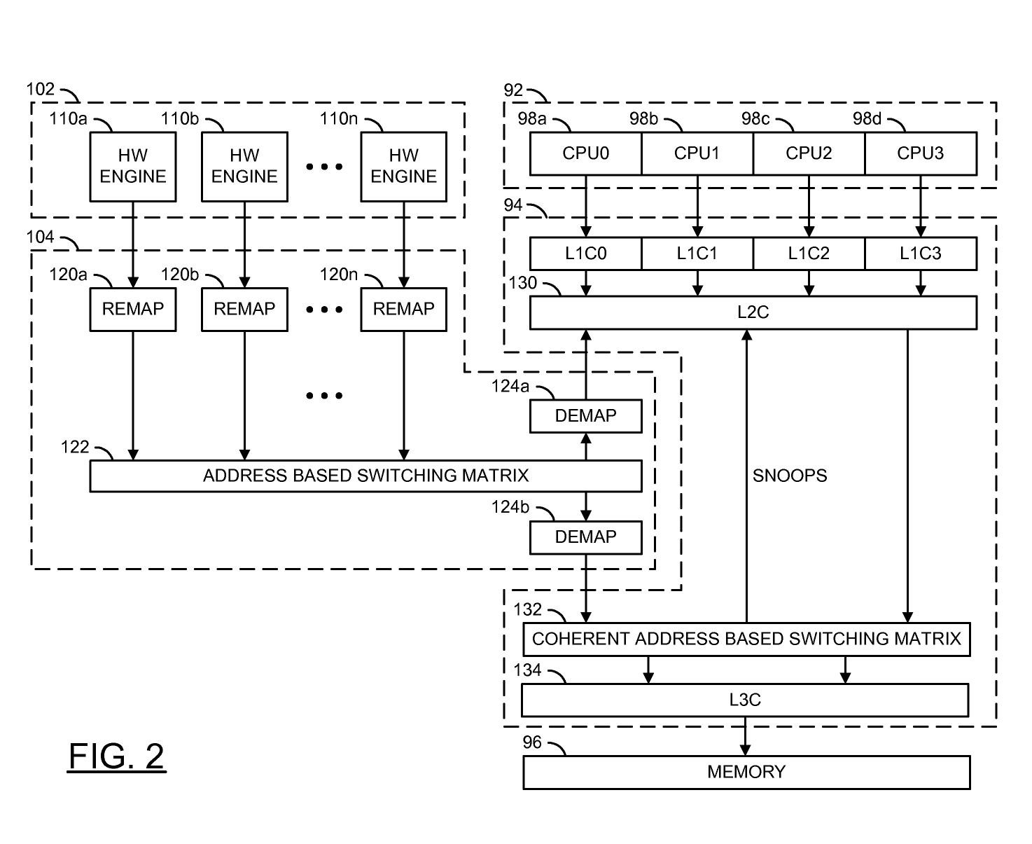

Referring to FIG. 2, a detailed block diagram of an example implementation of the apparatus 90 is shown in accordance with an embodiment of the invention. The figure generally highlights the flow of the addresses through the apparatus 90. The circuit 92 generally comprises one or more blocks (or circuits) 98a-98d. The circuit 94 generally comprises one or more blocks (or circuits) implementing level-1 caches (e.g., L1C0-L1C3), a block (or circuit) 130, a block (or circuit) 132 and a block (or circuit) 134. The circuit 102 generally comprises one or more blocks (or circuits) 110a-110n. The circuit 104 generally comprises one or more blocks (or circuits) 120a-120n, a block (or circuit) 122 and multiple blocks (or circuits) 124a-124b. The circuits 98a to 134 may represent modules and/or blocks that may be implemented as hardware, software, a combination of hardware and software, or other implementations.

Each circuit 98a-98d is shown implementing a central processor unit (e.g., CPU) circuit. The circuits 98a-98d are operational to execute software that interacts with the circuits 98 and 102 through the circuit 94. The circuits 98a-98d receive instructions and send and receive data via individual signals (or components) within the signal C.

Each circuit 110a-110n is shown implementing a hardware engine circuit. The circuits 110a-110n are each operational to preform one or more dedicated operations. Each circuit 110a-110n is in direct communication with a corresponding circuit 120a-120n. The circuits 110a-110n send and receive data and information via individual signals within the signal DATA. The addresses are sent to the circuit 104 as respective signals (or components) within the signal HADDR1.

Each circuit 120a-120n is shown implementing a remapping circuit. The circuits 120a-120n are operational to modify the address values received from the respective circuits 110a-110n per a corresponding cache allocation priority. The remapping is based on an evaluation of the quality of service identifiers, a range of the transaction identifiers and/or an address range of the access requests. The address remapping function creates aliases of the incoming addresses by extending the address vectors by a single bit (e.g., appending a new most significant bit). An additional bit is set if a transaction operation code has a quality of service that is higher than set by software, range of transaction identifier/address range that is within a range set by the software to route transactions thru the level-2 cache. Otherwise, the additional bit is cleared. The modified addresses are presented to the circuit 122.

The circuit 122 is shown implementing an address based switching matrix. The circuit 122 is operational to route the address values from the circuits 120a-120n to either of the circuits 124a-124b based on the values of the new bits appended to the addresses. The address based switching matrix primarily implements an N-to-2 multiplexer. The newly added bits of the incoming (or extended) addresses are used to select between a bus connecting to the level-2 cache and another bus connecting to the level-3 cache (or directly to the circuit 96). If the new bit is in a particular state (e.g., a logical one or set state), the addresses are routed to the circuit 124a. If the new bit is in an opposite state (e.g., a logical zero or cleared state), the addresses are routed to the circuit 124b. In some embodiments, the switching matrix implements an N-to-M multiplexer, where M z 3, and two or more new bits are added to each address by the circuit 120a-120n. Therefore, the circuit 122 can route the extended addresses among multiple (e.g., 3 or more) different levels of cache (e.g., L2, L3 and L4) and/or memory (e.g., L2, L3 and memory) based on the new bits.

Each circuit 124a-124b is shown implementing a demapping circuit. The circuits 124a-124b are operational to generate the addresses in the signal HADDR2 by removing the new bits added by the circuits 120a-120n. Demapping to the original addresses ensures cache coherency. The resulting address values are presented from the circuit 124a to the circuit 130 and from the circuit 124b to the circuit 132.

Each circuit L1C0-L1C3 is shown implementing a level-1 cache. The level-1 caches are operational to provide fast first-level caching functions for the circuit 98a-98d, respectively. The level-1 caches exchange data and instructions directly with the circuits 98a-98d and the circuit 130.

The circuit 130 is shown implementing a level-2 cache circuit. The circuit 130 is operational to perform second level caching functions. The circuit 130 exchanged data and instructions directly with the level-1 caches, the circuit 124a and the circuit 132.

The circuit 132 is shown implementing a coherent address based switching matrix circuit. The circuit 132 is operational to exchange data and instructions between the circuits 134, 124b and 130. A signal (e.g., SNOOPS) is used to maintain coherency between the level-2 cache data of the circuit 130 and the level-3 cache data of the circuit 134.

The circuit 134 is shown implementing a level-3 cache. The circuit 134 is operational to perform third-level caching functions. The circuit 134 exchanges data and instructions directly with the circuit 96 and the circuit 132.

In some embodiments where a single circuit 110a-110n generates multiple data structures, one or more structures can be allocated to the level-2 cache while one or more other structures are allocated to the level-3 cache. For example, the circuits 110a-110n implement different configuration registers for the different quality of service values, the different read/write opcodes for the read/writes related to a control structure and for data structures. The circuits 120a-120n thus process the different structures based on the configuration information.

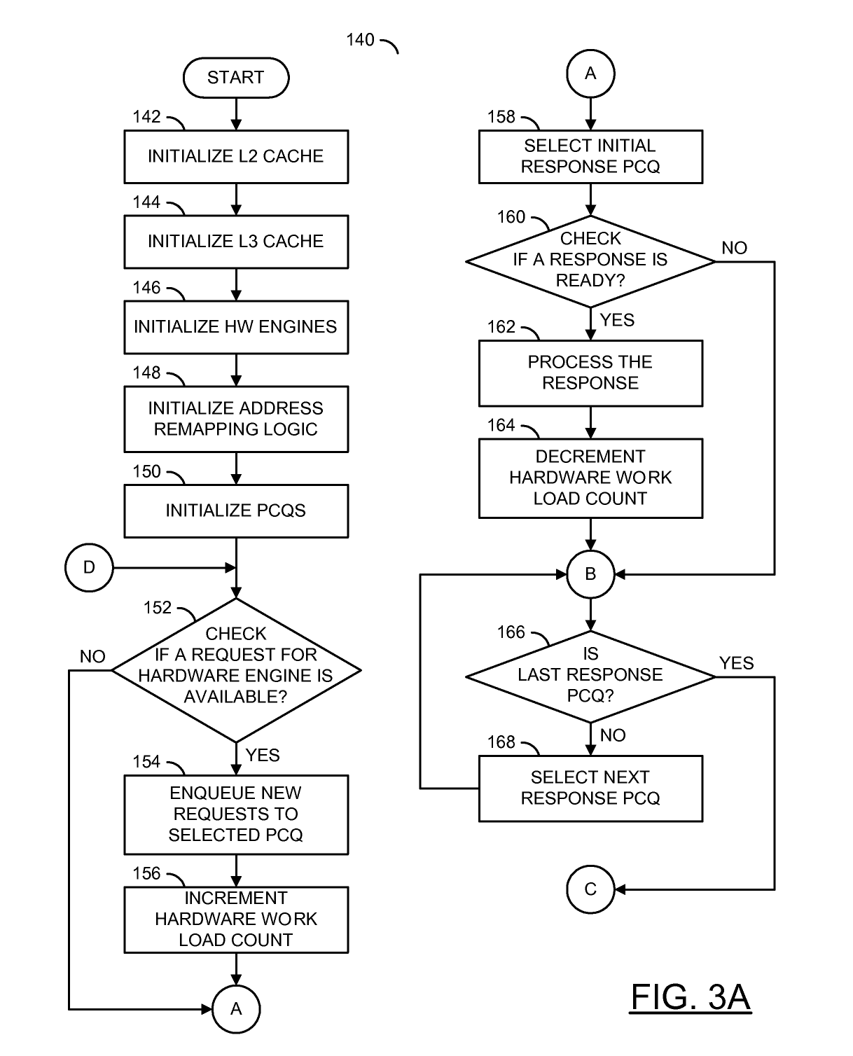

Referring to FIGS. 3A-3B, a flow diagram of an example implementation of a method 140 for selecting between the cache levels of the circuit 94 is shown. The method (or process) 140 is implemented in the circuit 90. The method 140 generally comprises a step (or state) 142, a step (or state) 144, a step (or state) 146, a step (or state) 148, a step (or state) 150, a step (or state) 152, a step (or state) 154, a step (or state) 156, a step (or state) 158, a step (or state) 160, a step (or state) 162, a step (or state) 164, a step (or state) 166, a step (or state) 168, a step (or state) 170, a step (or state) 172, a step (or state) 174 and a step (or state) 176. The steps 142 to 176 may represent modules and/or blocks that may be implemented as hardware, software, a combination of hardware and software, or other implementations.

In the steps 142-148, the circuits 130, 134, 102 and 120a-120n are initialized, respectively, by the circuit 92. Producer-consumer queues (e.g., PCQs) are initialized in the step 150 by the software executing in the circuit 92. In the step 152, a check is made to determine if an access request has been made for one or more of the circuits 110a-110n. If at least one access request has been made, the new requests are enqueued to selected producer-consumer queues in the step 154. A hardware work load count is incremented by the circuit 92 in the step 156.

Once access requests are available in the producer-consumer queues, an initial response producer-consumer queue is selected in the step 158 and the access request is considered. A check is performed in the step 160 to determine if a response to the access request is ready. If the response is ready, the response is processed by the originating circuit 110a-110n in the step 162. Next, the hardware work load count is decremented by the circuit 92 in the step 164.

A check is made in the step 166 by the circuit 104 for additional response producer-consumer queues. If the just-serviced response was not the last response, the next response producer-consumer queue is selected by the circuit 104 in the step 168. Once the last response producer-consumer queue has been serviced, the method 140 continues with the step 170 (see FIG. 3B).

In the step 170, a check is made to determine if the current hardware work load count is greater than an average hardware work load. If not, the method 140 continues with the step 174. If the current count is greater than the average count, the circuit 92 programs a level-2 cache access quality of service/range of transaction identifiers/address range threshold for the circuits 120a-120n to a higher value/different range in the step 172. In the step 174, a check is made to determine if the current hardware work load count is less than the average hardware work load. If not, the method 140 loops back to the step 152 to check for additional requests. If the current count is less than the average count, the circuit 92 programs the level-2 cache access quality of service/range of transaction identifiers/address range threshold for the circuits 120a-120n to a lower value in the step 176. The method 140 subsequently loops back to step 152 to check for additional requests.

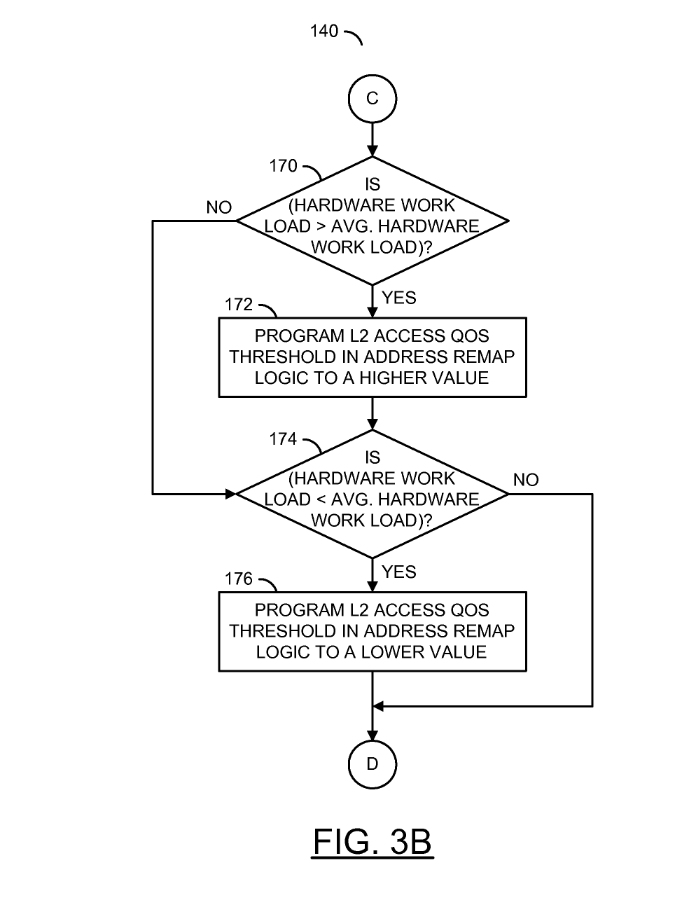

Referring to FIG. 4, a flow diagram of an example implementation of a method 200 for remapping the addresses is shown. The method (or process) 200 is implemented by the circuits 120a-120n. The method 200 generally comprises a step (or state) 202, a step (or state) 204, a step (or state) 206, a step (or state) 208 and a step (or state) 210. The steps 202 to 210 may represent modules and/or blocks that may be implemented as hardware, software, a combination of hardware and software, or other implementations.

As the system load increases any of the deciding elements (e.g., the quality of service identifiers, the access request and/or the address range) are reprogrammed to stop allocation of the subset of data structures into the level-2 cache. The reprogramming prevents pollution of the level-2 cache and thus increases performance of the circuits 98a-98d. As the system load reduces, the data structures are again allocated into the level-2 cache. Procedures to change allocation of data structures into lower level of caches, such as in the level-3 cache instead of the level-2 cache, are to reconfigure the remap logic. Procedures to change allocation of data structures into higher level of caches, such as in the level-2 cache instead of the level-3 cache, involve common lower level cache maintenance before the switch over.

In the step 202, a check is made to see if the level-2 cache is enabled. If the level-2 cache is not enabled, the method 200 continues with the step 210 where the new most significant bit (e.g., MSB) in the address is cleared (e.g., a logical zero or cleared state). If the level-2 cache is enabled, another check is made in the step 204 to determine if the current transaction quality of service value of the current access request is greater than the level-2 cache access quality of service threshold. If not, the method 200 continues with the step 210 to clear (or reset) the most significant bit in the transaction address. If the transaction quality of service value is greater than the level-2 cache access threshold value, the method 200 continues with the step 206. In the step 206, a check is made to see if the transaction opcode is an allocate-on-read opcode, an allocate-on-write opcode or something else. If the transaction opcode is not the allocate-on-read or the allocate-on-write, the method 200 continues with the step 210. Otherwise, the most significant bit in the transaction address is set (e.g., a logical one or set state) in the step 208.

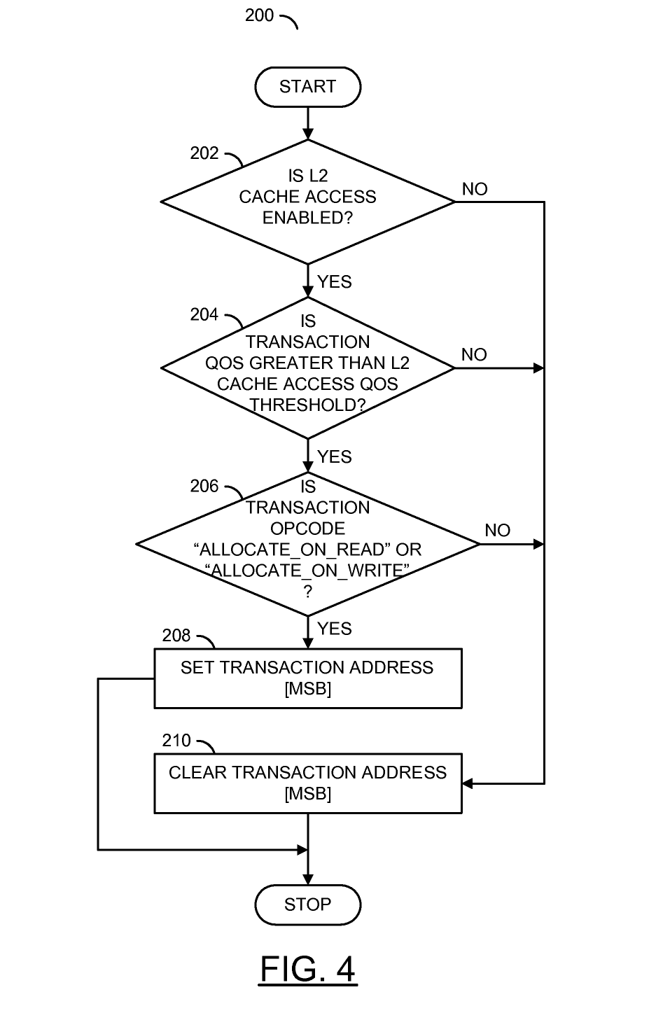

Referring to FIG. 5, a flow diagram of an example implementation of a method 220 for routing the remapped addresses is shown. The method (or process) 220 is implemented in the circuit 122. The method 220 generally comprises a step (or state) 222, a step (or state) 224 and a step (or state) 226. The steps 222 to 226 may represent modules and/or blocks that may be implemented as hardware, software, a combination of hardware and software, or other implementations.

In the step 222, a check is made by the circuit 122 to determine if the new most significant bit in the transaction address is set or cleared. If the new bit is set, the circuit 122 forwards the access request address to circuit 124a in the step 224. If the new bit is cleared, the circuit 122 forwards the access request address to the circuit 124b in the step 226.

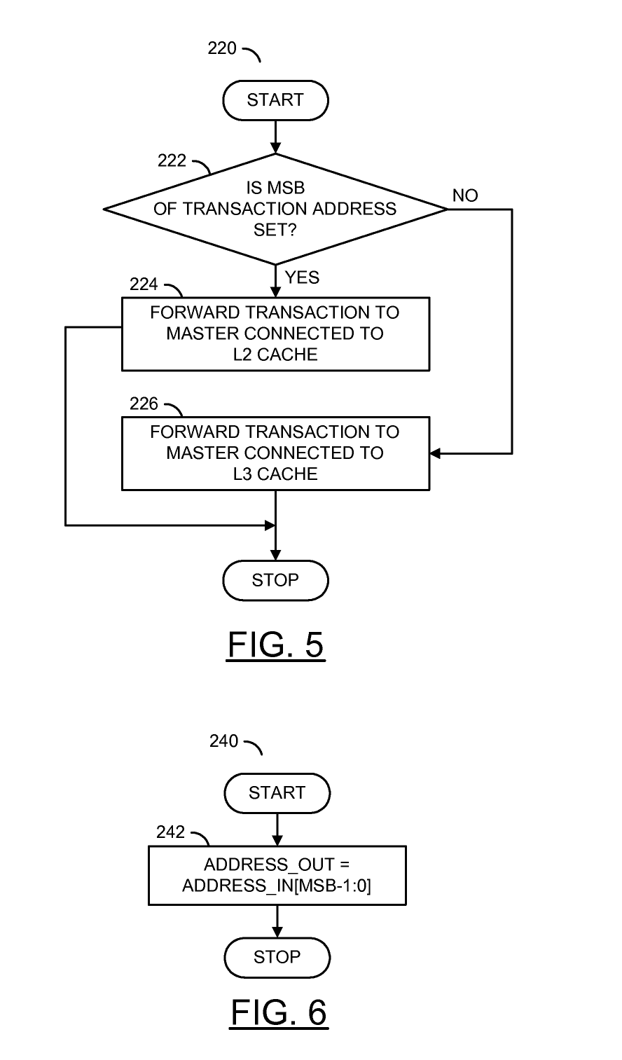

Referring to FIG. 6, a flow diagram of an example implementation of a method 140 for demapping the addresses is shown. The method (or process) 240 is implemented in each of the circuits 124a-124b. The method 240 generally comprises a step (or state) 242. The step 242 may represent modules and/or blocks that may be implemented as hardware, software, a combination of hardware and software, or other implementations.

When either circuit 124a or 124b receives an address from the circuit 122, the circuit 124a-124b removes in the step 242 the new most significant bit that was added by the circuits 120a-120n. The resulting addresses are presented in the signal HADDR2 to the circuit 94. The demapped addresses in the signal HADDR2 are generally the same as the original addresses in the signal HADDR1.

The circuits 110a-110n and the software executing in the circuits 98a-98d interact with each other via first-in-first-out like producer-consumer queues. With requests for a hardware engine, the software is the producer and the hardware engine is the consumer. For responses, the hardware engine is the producer and the software is the consumer. The producer increments a write pointer when a new entry is added to a queue. The producer may optionally interrupt the consumer of the queue to signal the new entry. The consumer consumes an entry then increments a read pointer. Multiple request queues and response queues are implemented for each circuit 110a-110n to support multiple quality of services. The software also monitors occupancy based on differences in the write pointers and the read pointers. The software calculates the work load based on the number of outstanding responses from the circuits 110a-110n, more outstanding responses indicate a higher work load.

The functions performed by the diagrams of FIGS. 1-6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, (radio frequency integrated circuits), ASSPs RFICs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a first circuit configured to generate an access request having a first address; and
a second circuit configured to (i) initiate a change in a load value of a cache system in response to said access request, wherein (a) said cache system has a plurality of levels and (b) said load value represents a work load on said cache system, (ii) generate a second address from said first address in response to said load value and (iii) route said access request to one of said levels in said cache system in response to said second address.

2. The apparatus according to claim 1, wherein said generation of said second address includes appending a new bit to said first address.

3. The apparatus according to claim 2, wherein said routing of said access request is in response to said new bit.

4. The apparatus according to claim 1, wherein said second circuit is programmed with a threshold value in response to said load value.

5. The apparatus according to claim 4, wherein said second circuit is further configured to select between said levels of said cache system in response to a quality of service of said access request relative to said threshold value.

6. The apparatus according to claim 1, wherein said generating of said second address is based on one or more of (i) a quality of service of said access request, (ii) an operation code of said access request and (iii) a range containing said first address.

7. The apparatus according to claim 1, wherein said access request is routed to one of a second level and a third level of said cache system.

8. The apparatus according to claim 7, further comprising a third circuit configured to access cached data in a first level of said cache system.

9. The apparatus according to claim 1, wherein said apparatus is implemented as one or more integrated circuits.

10. A method for dynamic selection of a cache level, comprising the steps of:
(A) generating in a first circuit an access request having a first address;
(B) initiating in a second circuit a change in a load value of a cache system in response to said access request, wherein (i) said cache system has a plurality of levels and (ii) said load value represents a work load on said cache system
(C) generating a second address from said first address in response to said load value; and
(D) routing said access request to one of said levels in said cache system in response to said second address.

11. The method according to claim 10, wherein said generating of said second address includes appending a new bit to said first address.

12. The method according to claim 11, wherein said routing of said access request is in response to said new bit.

13. The method according to claim 10, further comprising the step of:
programming a threshold value in response to said load value.

14. The method according to claim 13, further comprising the step of:
selecting between said levels of said cache system in response to a quality of service of said access request relative to said threshold value.

15. The method according to claim 10, wherein said generating of said second address is based on one or more of (i) a quality of service of said access request, (ii) an operation code of said access request and (iii) a range containing said first address.

16. The method according to claim 10, wherein said access request is routed to one of a second level and a third level of said cache system.

17. The method according to claim 16, further comprising the step of:
accessing cached data in a first level of said cache system from a third circuit.

18. An apparatus comprising:
means for generating an access request having a first address;
means for initiating a change in a load value of a cache system in response to said access request, wherein (i) said cache system has a plurality of levels and (ii) said load value represents a work load on said cache system;
means for generating a second address from said first address in response to said load value; and
means for routing said access request to one of said levels in said cache system in response to said second address.
